(19) United States
(12) Patent Application Publication
(10) Pub. No.: US 2015/0229752 A1
(43) Pub. Date: Aug. 13, 2015

(54) MOBILE SECURITY APPLICATION

(71) Applicant: Roderick Andrew Coles, Colorado Springs, CO (US)

(72) Inventor: Roderick Andrew Coles, Colorado Springs, CO (US)

(21) Appl. No.: 14/621,194

(22) Filed: Feb. 12, 2015

Related U.S. Application Data
(60) Provisional application No. 61/939,610, filed on Feb. 13, 2014.

(51) Int. Cl. H04M 1/725; H04M 3/44; G06F 3/0482; G06F 3/01; G06F 3/0484

(52) U.S. Cl. CPC H04M 1/72541; G06F 3/017; G06F 3/04842; G06F 3/0482; H04M 3/44

(57) ABSTRACT

An application for a mobile device allows a user to let a monitoring center know that they are in trouble without the requirement of using the user interface of the mobile device to navigate to the app menu to select the app and select an option to send an alarm. The app allows the user to send alarms for different types of events. The mobile device's Inertial Measurement Unit is used to record and trigger a three dimensional movement gesture pattern of the mobile device which is associated with certain events and actions. To make the process even more unique a fourth dimension of time is added into the process. Time can affect the gesture pattern in two ways. First, there will be an overall time to complete the three dimensional movement for the gesture pattern, and second, a time to complete each individual movement that comprises the gesture pattern.

### CROSS-REFERENCES TO RELATED APPLICATIONS

This application claims the benefit of U.S. Provisional Application Ser. No. 61/939,610 filed on Feb. 13, 2014 titled “MOBILE SECURITY APPLICATION” which is incorporated herein by reference in its entirety for all that is taught and disclosed therein.

### BACKGROUND

This application relates to personal security, and more particularly, to utilizing an application on a mobile device to enhance personal security.

### SUMMARY

This Summary is provided to introduce in a simplified form a selection of concepts that are further described below in the Detailed Description. This Summary is not intended to identify key or essential features of the claimed subject matter, nor is it intended to be used to limit the scope of the claimed subject matter.

A mobile application, or “app,” allows a user to let a monitoring center or other entity know that they are in trouble without the requirement of first selecting the app that runs on a mobile device, such as a Smartphone, and use the user interface of the mobile device to navigate to the app menu, selecting the app through the interface, and selecting an option to send an alarm. The app allows the user to send alarms for different types of events so a personal attack can be distinguished from a medical alert. The invention uses the mobile device's Inertial Measurement Unit (IMU) to trigger and record a three dimensional physical movement pattern of the device which it maps to certain events and actions. To make the process even more unique, a fourth dimension of time is added into the process. Time can affect the gesture pattern in two ways. First, there will be an overall time to complete the three dimensional movement of the gesture pattern, and second, a time to complete each individual movement that comprises the gesture pattern.

As used herein, “at least one,” “one or more,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” and “A, B, and/or C” means A alone, B alone, C alone, A and B together, A and C together, B and C together, or A, B, and C together. When each one of A, B, and C in the above expressions refers to an element, such as X, Y, and Z, or class of elements, such as X1-Xm, Y1-Yn, and Z1-Zo, the phrase is intended to refer to a single element selected from X, Y, and Z, a combination of elements selected from the same class (e.g., X1 and X2) as well as a combination of elements selected from two or more classes (e.g., Y1 and Z3).

It is to be noted that the term “a entity” or “an entity” refers to one or more of that entity. As such, the terms “a” (or “an”), “one or more,” and “at least one” can be used interchangeably herein. It is also to be noted that the terms “comprising,” “including,” and “having” can be used interchangeably.

The term “means” as used herein shall be given its broadest possible interpretation in accordance with 35 U.S.C., Section 112, Paragraph 6. Accordingly, a claim incorporating the term “means” shall cover all structures, materials, or acts set forth herein, and all of the equivalents thereof. Further, the structures, materials or acts and the equivalents thereof, shall include all those described in the summary of the invention, brief description of the drawings, detailed description, abstract, and claims themselves.

### BRIEF DESCRIPTION OF THE SEVERAL VIEWS OF THE DRAWINGS

FIG. 1 shows a user in a threatening situation where the user does not have time to operate their mobile device to call 911 for help.

FIG. 2 shows the user simply moving the mobile device in a previously recorded gesture pattern to activate the app.

FIGS. 3A, 3B, and 3C show the user moving the mobile device in a gesture pattern in four dimensions (x, y, z, and time) that was previously recorded and linked to an alarm.

FIG. 4 shows the previously defined alarm arriving at an alarm receiving center.

FIG. 5 shows how the Inertial Measurement Unit on the mobile device can measure movement in six planes.

FIG. 6 shows a method for recording a trigger gesture pattern and recording at least one event gesture pattern.

FIG. 7 shows a method for utilizing the mobile device to initiate a trigger gesture pattern and duplicate an event gesture pattern to send an alarm.

### DETAILED DESCRIPTION

The invention may be implemented as a computer process, a computing system, or as an article of manufacture such as a computer program product. The computer program product may be a computer storage medium readable by a computer system and encoding a computer program of instructions for executing a computer process.

With the computing environment in mind, embodiments of the present invention are described with reference to logical operations being performed to implement processes embodying various embodiments of the present invention. These logical operations are implemented (1) as a sequence of computer implemented steps or program modules running on a computing system and/or (2) as interconnected machine logic circuits or circuit modules within the computing system. The implementation is a matter of choice dependent on the performance requirements of the computing system implementing the invention. Accordingly, the logical operations making up the embodiments of the present invention described herein are referred to variously as operations, structural devices, acts, applications, or modules. It will be recognized by one skilled in the art that these operations, structural devices, acts, applications, and modules may be implemented in software, firmware, special purpose digital logic, and any combination thereof without deviating from the spirit and scope of the present invention as recited within the claims attached hereto.

Referring now to the Figures, like reference numerals and names refer to structurally and/or functionally similar elements thereof, and if objects depicted in the figures that are covered by another object, as well as the tag line for the element number thereto, may be shown in dashed lines.

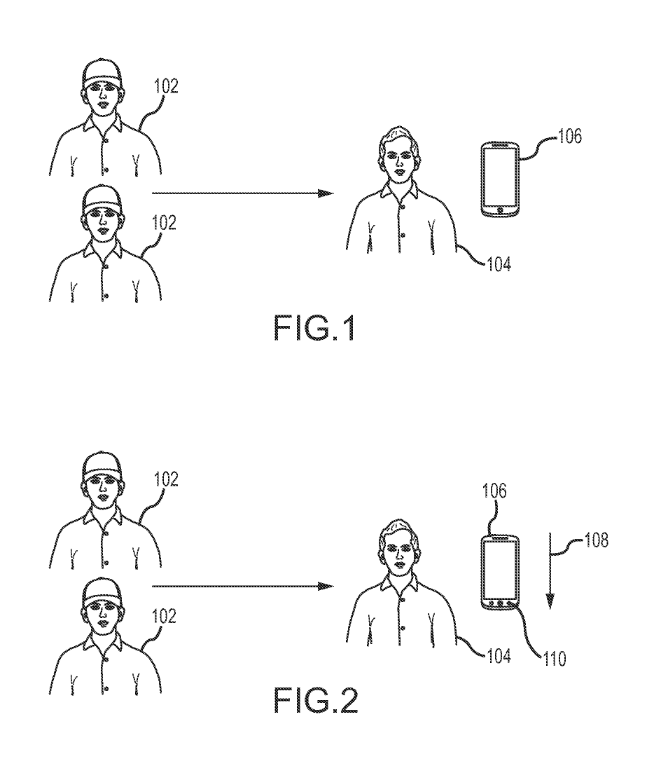

FIG. 1 shows a user in a threatening situation where the user does not have time to operate their mobile device to call 911 for help. Referring now to FIG. 1, two individuals 102 are rapidly approaching a user 104 in a threatening manner. In such a threatening situation, trying to operate a mobile device 106 can be difficult. There are numerous mobile device apps disclosed in the prior art for requesting help, but they all require the app to be started or brought into focus on the mobile device, and an icon touched or swiped on the display screen, or other more detailed user actions, in order to request help. There may not be enough time in a threatening situation for the user 104 to accomplish all of these actions.

FIG. 2 shows the user simply moving the mobile device in a previously recorded gesture pattern to activate the app. Referring now to FIG. 2, the user 104 simply moves the mobile device 106 downwards sharply as indicated by arrow 108, which activates up the app because the g-force exceeded a previously calibrated value. The mobile device 106 must be turned on, but does not have to be in use with the display activated. The process is initiated by duplicating a trigger gesture pattern. The trigger gesture pattern is a previously recorded gesture pattern that triggers the app to start the process of watching for other gesture patterns. The trigger gesture pattern should be a simple gesture pattern that can't be accidentally reproduced easily, such as shaking the mobile device 106 hard three times. This will trigger the app to start watching for other previously recorded gesture patterns. The app could also be programmed to begin watching for gesture patterns by the pressing of a programmable external button 110 on the mobile device 106 if so desired.

The process is initiated by the user 104 moving the mobile device 106 downwards sharply, forcing the accelerometer to exceed a previously recorded threshold value. Typically this is measured in g-force, so a measurement exceeding two g's for example may trigger the app to begin watching for a gesture pattern of movement that has previously been recorded by the user 104 utilizing the app.

The IMU within the mobile device 106 consists of three components: an accelerometer, a gyroscope, and a magnetometer (digital compass). An accelerometer measures accelerations. This is useful to measure changes in velocity and changes in position. Accelerometers are usually used for measuring small movements. Also note that gravity acts like a continuous acceleration upward (via Einstein's equivalency principle), so a multiple-axis accelerometer can also be used as an absolute orientation sensor in the Up-Down plane.

A gyroscope measures either changes in orientation (regular gyro or integrating rate gyro) or changes in rotational velocity (rate gyro).

A magnetometer measures magnetic fields. Because the earth has a significant magnetic field, the magnetometer can be used as a compass. As such it is useful to determine absolute orientation in the North/South and East/West planes.

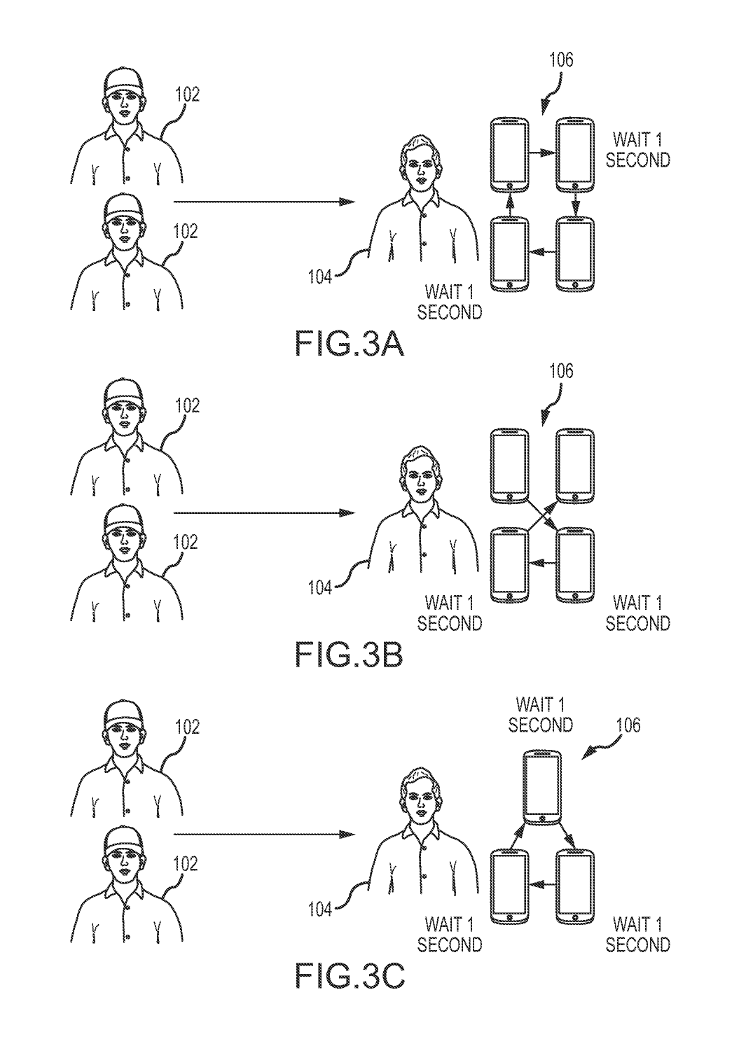

FIGS. 3A, 3B, and 3C show the user moving the mobile device in a gesture pattern in four dimensions (x, y, z, and time) that was previously recorded and linked to a an alarm. Referring now to FIG. 3A, after the app has detected the trigger gesture pattern, it will use the mobile device 106 IMU output to look for a gesture pattern of movement of the mobile device 106. The gesture pattern shown in FIG. 3A is a simple square gesture pattern, which could trigger a personal attack alarm by the app. As well as detecting the gesture pattern, the app will measure the time taken in relation to the gesture pattern with the internal clock in the mobile device 106. So, for the square gesture pattern, the user 104 may decide to wait for one second at the top right and bottom left of the gesture pattern when recording the gesture pattern in the app. If this wait time is not duplicated within a user defined error margin, the gesture pattern will not be deemed to have been accurately reproduced and the set of instructions stored for that gesture pattern, such as sending an alarm, will not be executed. Different gesture patterns are recorded and stored within the app and can be used for various events. A cross gesture pattern as shown in FIG. 3B could trigger a medical alert alarm. A triangle gesture pattern as shown in FIG. 3C could trigger a “call my mobile device I need help” alarm.

The app measures and records the movement of the mobile device 106 in six different planes as well as measuring the time that each part of the gesture pattern takes, and the overall time. Additionally, the accelerometer will measure the acceleration of each motion in the gesture pattern, which is sampled as g-force or meters per second squared. All parameters will have to be within the pre-defined error margins when the motion is used in a live situation. So to accurately reproduce a gesture pattern and send an alarm to an Alarm Receiving Center (ARC) or any other external entity, a gesture pattern is first recorded in four dimensions: x, y, z (six planes) and time and stored in the mobile device 106.

Once a gesture pattern detected has been matched to a recorded event gesture pattern, the set of instructions are executed, which may include transmitting an alarm digitally over the Internet. In another embodiment, the alarm may be a direct connection to an ARC using General Packet Radio Service (GPRS) or similar protocol. In another embodiment, the alarm may be transmitted via the SMS (Short Messaging Protocol), or use a hosted managed network to deliver the alarm. The alarm will provide information to identify the user 104, such as their phone number, caller ID, etc. It will deliver location information either through Global Positioning System (GPS) or triangulation. Triangulation measures signal strength at nearby cell towers and can provide an estimation of location. The app will also allow for the absence of a gesture pattern after the trigger gesture pattern, such as when the user 104 has their mobile device 106 removed from them by an assailant.

FIG. 4 shows the previously defined alarm arriving at an alarm receiving center. Referring now to FIG. 4, each gesture pattern recorded and stored is programmed with instructions for a specific response or set of responses. One gesture pattern may trigger an alarm sent over communication channel 120 to an ARC 112 and also send GPS data, but not open an audio channel. A different gesture pattern may open up an audio channel 114 to a telephone 116 of the police 118. Another gesture pattern may start a video recorder of the mobile device 106 and stream the audio and video data to the ARC 112. Another gesture pattern may trigger an alarm to the ARC 112, which then will try and call the user 104 back on the mobile device 106, or initiate a call to a predefined third party. The application allows for different options that can be user defined, because the requirements of each user 104 may be quite variable.

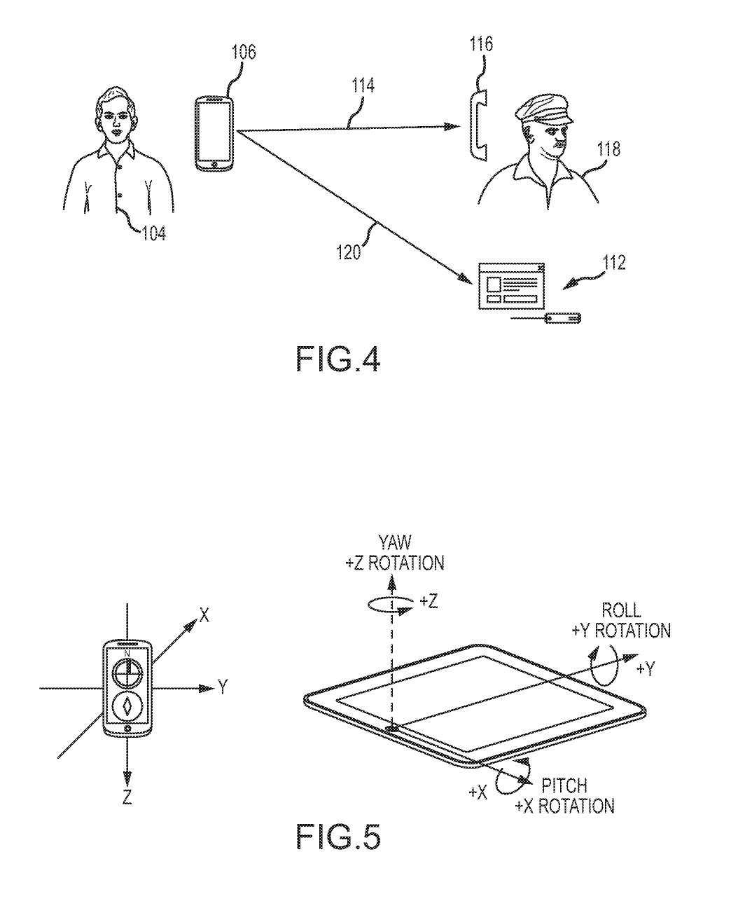

FIG. 5 shows how the Inertial Measurement Unit on the mobile device can measure movement in six planes. Referring now to FIG. 5, the IMU can measure movement in six different planes to allow simple and complex gesture patterns to be recorded and then linked to specific alarms/signaling events. The six planes are up, down, left, right, forward, and backwards, and roll, pitch, and yaw rotations about the x, y, and z axis.

A gesture pattern could also be recorded to cancel an alarm. In a situation where the user 104 accidentally initiates the trigger gesture pattern, activating the app which starts looking for an event gesture pattern, another gesture pattern of movement could cancel the monitoring of the app for further event gesture patterns. Similarly, the absence of a gesture pattern could trigger an alarm. The user 104 may have activated the app with the trigger gesture pattern, and their mobile device 106 is taken from them by an assailant before they can move the mobile device 106 in an event gesture pattern. The absence of an event gesture pattern within a certain period of time from the trigger gesture pattern could trigger an alarm to an ARC.

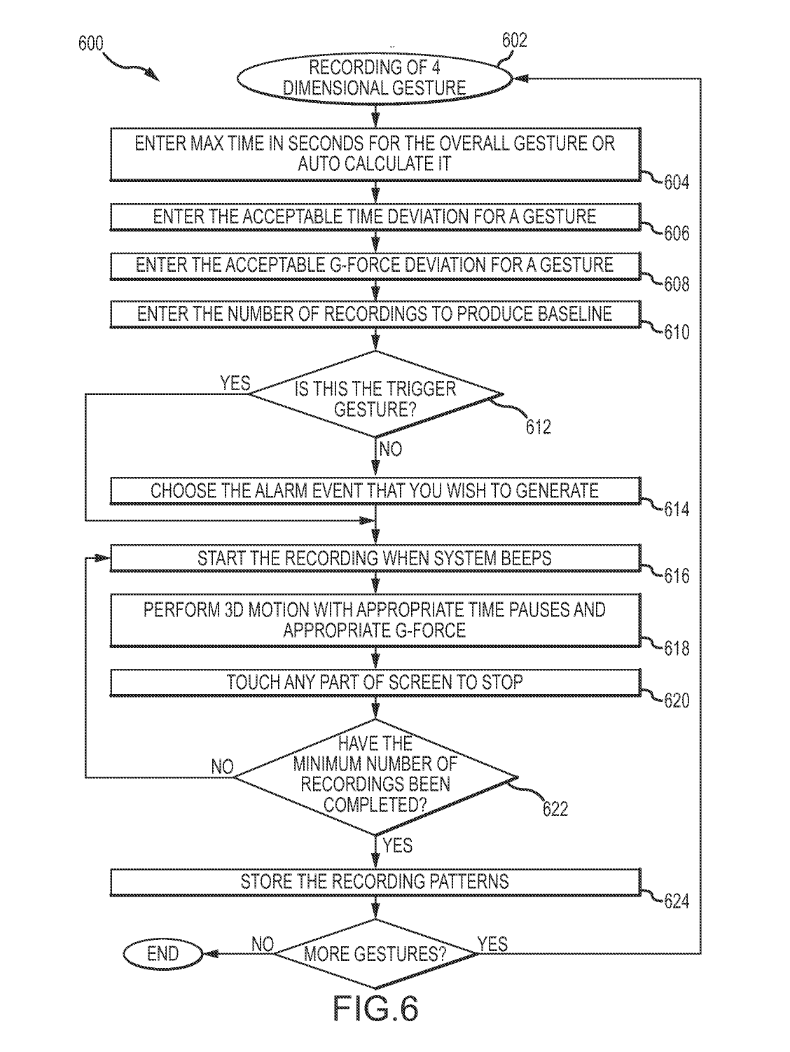

FIG. 6 shows a method for recording a trigger gesture pattern and recording at least one event gesture pattern. Referring now to FIG. 6, only one trigger gesture pattern can be recorded, but multiple event gesture patterns may be recorded, each having its own set of instructions which may include reporting and alarm parameters. The method 600 begins in block 602 where the recording function for the app that runs on the mobile device 106 is selected to begin the recording of a four-dimensional gesture pattern. Next, a series of parameters will be entered by the user through the app (blocks 604, 606, 608, and 610). First, the whole gesture pattern must be completed in a maximum amount of time for it to be valid. That maximum amount of time is entered in block 604 by the user, or it can be auto calculated. If it is auto-calculated, then the app will generate the time after the user has recorded the gesture pattern.

In block 606 the user enters the acceptable time deviation for a gesture pattern. For example, entering a 50% time deviation would allow a one second pause to deviate between 0.5 to 1.5 seconds. For each motion within a gesture pattern, g-force (g) is measured. In block 608, the user enters the acceptable g-force deviation for a gesture pattern. For example, entering a 50% g-force deviation would allow a 2 g-force motion to deviate between 1 g-force to 3 g-force. Next, in block 610 the user enters the number of recordings that are averaged together to produce a baseline recording of the gesture pattern. The more recordings that are done, the better the averaged baseline recording will be. The app will default to three recordings, which are averaged together to produce the baseline recording. In another embodiment, different upper and lower limits for g-force deviation are set. For example, a much higher g-force, such as 4 g-force up to 6 g-force, than what was recorded may be accepted due to the probability that a user in a real world situation may be more likely to move the mobile device 106 harder due to heightened fear, excitement, and/or adrenaline affecting their actions.

The app allows only one trigger gesture pattern. The trigger gesture pattern should be simple and something that cannot easily happen by accident. The trigger gesture pattern will start the process for other gesture patterns that follow. Decision block 612 determines if the user has selected to record a trigger gesture pattern. If no, control passes to block 614. If yes, control passes to block 616.

In block 614 the user chooses the alarm event that the user wants to associate with the gesture pattern to be recorded next. The user will choose the event to be sent to an external monitoring center or other outside body from a list of predefined events. Alarm events are pre-defined in the app and are also linked to other actions such as sending a signal to a monitoring center, calling an authority or 911 center, calling another party or monitoring center, sending SMS, MMS, Video or Audio clips to external parties, etc. Examples of events may include, but are not limited to: PA—Personal Attack; MA—Medical Alert; TS—Threatening Situation; CI—Check-In; etc. A Check-In event is simply an alert notifying another system or person that the user is somewhere at a certain time. For example, a realtor may Check-In (an alert sent to the office) outside the house of every showing. The realtor would then be expected to Check-In again after a predetermined period of time, such as thirty or sixty minutes. If the realtor does not Check-In then an alarm can be raised back at the office. This kind of Check-In can also be used as a dead man type of functionality—someone may be required to Check-In every hour to show that they are still okay.

Once all the parameters for the recording are entered the recording process can start. In block 616 the app generates an audible signal, such as a beep or a tone, to inform the user to start the motions that will make up the recorded gesture pattern, which may be a trigger gesture pattern if a trigger gesture pattern has not yet been recorded, or a gesture pattern for an alarm event. The app begins the recording.

In block 618 the user performs a 3D gesture pattern with appropriate time pauses and appropriate g-force. The 3D gesture pattern is made and the app measures and records the movement in six different planes as well as measuring the time that each part of the gesture pattern takes and the overall time to complete the gesture pattern. Additionally the accelerometer will measure the acceleration of each motion in the gesture pattern. This is sampled as g-force or meters per second squared. For example, for a triangular gesture pattern (see FIG. 3C), the user begins by holding the mobile device 106 in the top position and waits approximately 1 second. The user then moves the mobile device 106 downward and to the right with an approximate 2 g force, and waits approximately one second. The user then moves the mobile device 106 horizontally to the left with an approximate 0.5 g force, and waits approximately one second. The user then moves the mobile device 106 to the top position with an approximate 2 g force, and waits approximately one second. When the user completes the gesture pattern, in block 620 the user touches any part of the screen to stop the recording, which is stored in a memory of the mobile device 106. Whether the user starts at the top or any other position does not matter. As long as the user is consistent, the complete gesture pattern can be recorded and an average established. The user can stop the recording at any time. In the example above the user waited one second and then touched the screen to stop the recording, making the one second part of the gesture pattern. If the user did not wait the one second before touching the screen, the gesture pattern would not have a wait time at the end. Overall, the gesture pattern is typically completed within a relatively short period of time. In one embodiment, the range is between 1.5 to 3.5 seconds.

In block 622 the app determines if the minimum number of recordings have been completed. If not, control returns to block 616 to record the gesture pattern again. If yes, control passes to block 624 where the series of recordings for the same gesture pattern are stored in a memory of the mobile device 106 and a baseline recording is derived from the series of recordings and stored in the memory of the mobile device 106. Subsequently, in live situations, all parameters for the gesture pattern have to fall within the predefined deviations for time and g-force to recognize the trigger event or alarm event.

Block 626 determines if the user has selected to record more gesture patterns. If yes, control returns to block 602 to repeat the method. If no, the method ends.

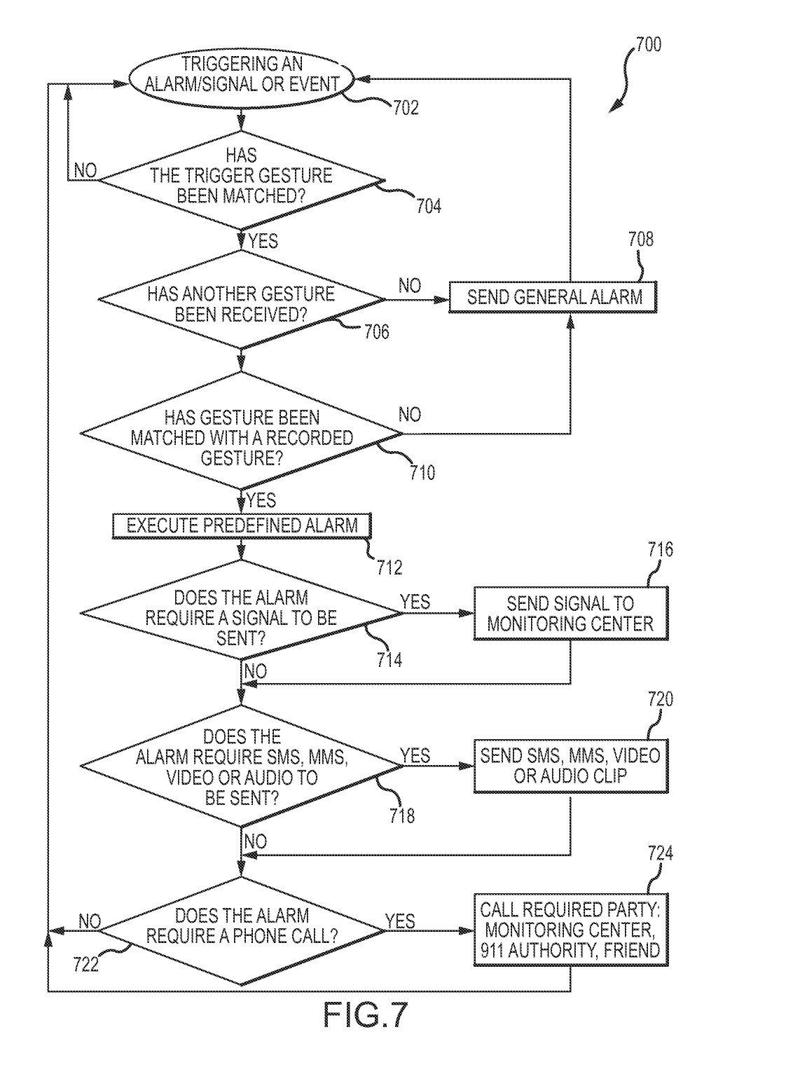

FIG. 7 shows a method for utilizing the mobile device to initiate a trigger gesture pattern and duplicate an event gesture pattern to send an alarm. Referring now to FIG. 7, the method 700 begins in block 702 after the mobile device 106 is powered on and the app begins monitoring for and detecting a trigger gesture pattern. In block 704 the app determines if a gesture pattern that has been detected matches with the previously recorded trigger gesture pattern. Only the trigger gesture pattern will cause the app to monitor for further gesture patterns associated with alarms. For example, if the user completed the triangle gesture pattern described above before making the trigger gesture pattern, nothing happens—the app will not do anything. If the gesture pattern detected does not match the previously recorded trigger gesture pattern, control returns to block 702.

If the gesture pattern detected matches the previously recorded trigger gesture pattern, then in block 706 the app monitors for a next gesture pattern. If no gesture pattern is detected within a predetermined period of time from receipt of the trigger gesture pattern, then in block 708 a more general type of predefined general alarm (not a specific alarm, such as a PA, MA, TS, or CI) is sent by the app to an ARC according to a predefined user option. Typically, the app will also send the user's GPS location should the ARC on its own initiative wish to dispatch resources or authorities to the user's location. Alternatively, the user may predetermine not to send any alarm at all in this circumstance. Control then returns to block 702.

When a next gesture pattern is detected in block 706 within the predetermined period of time from receipt of the trigger gesture pattern, block 710 determines if the next gesture pattern detected matches any previously recorded event gesture patterns within the predefined deviations set for the event gesture patterns. If there is no match, control returns to block 708 where a more general type of predefined general alarm as discussed above is sent by the app according to a predefined user option. This predefined general alarm may be the same as or different than the predefined general alarm that is sent when no gesture pattern is detected after the trigger gesture. Alternatively, the user may predetermine not to send any alarm at all in this circumstance. Control then returns to block 702.

When a match is found in block 710, in block 712 the execution of the predefined alarm begins. Block 714 the app determines if the predefined alarm requires an alarm signal to be sent to a monitoring center. If yes, then in block 716 an alarm signal is sent by the app to the monitoring center. If no, then block 718 the app determines if the predefined alarm requires an SMS message, a MMS message, a video clip, and/or an audio clip to be sent. If yes, then in block 720 the app sends the SMS message, the MMS message, the video clip, and/or the audio clip to the predetermined location. If no, in block 722 the app determines if the predefined alarm requires a telephone call. If yes, then in block 724 the app calls the predefined required party, such as a monitoring center, 911 authorities, a friend, emergency contact person, etc. After blocks 722 or 724, control returns to block 702 for the next gesture pattern to be detected. The method ends when the mobile device 106 is powered off.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. It will be understood by those skilled in the art that many changes in construction and widely differing embodiments and applications will suggest themselves without departing from the scope of the disclosed subject matter.

What is claimed is:

1. A method for mobile security, the method comprising the steps of:
(a) monitoring by an application running in a mobile device for a prerecorded trigger gesture pattern;
(b) detecting by the application a gesture pattern;
(c) determining by the application if the gesture pattern detected matches the prerecorded trigger gesture pattern;
(d) if the gesture pattern detected matches the prerecorded trigger gesture pattern, monitoring by the application for a next gesture pattern;
(e) detecting by the application the next gesture pattern;
(f) comparing by the application the next gesture pattern to a one or more prerecorded event gesture patterns; and
(g) when the next gesture pattern detected matches one of the one or more prerecorded event gesture patterns, executing by the application a set of instructions associated with the one or more prerecorded event gesture patterns that has been matched.

2. The method according to claim 1 further comprising the step of:
if the next gesture pattern is not detected with a predetermined period of time from detection of the prerecorded trigger gesture pattern, sending by the application a first predefined general alarm to an alarm receiving center.

3. The method according to claim 2 further comprising the step of:
if the next gesture pattern is detected within the predetermined period of time from detection of the prerecorded trigger gesture pattern but is not matched with any of the one or more prerecorded event gesture patterns, sending by the application a second predefined general alarm to the alarm receiving center.

4. The method according to claim 3 further comprising the step of:
sending by the application a GPS location of the mobile device along with the first predefined general alarm or the second predefined general alarm.

5. The method according to claim 1 further comprising the step of:
executing the set of instructions selected from the group consisting of one or more of an alarm signal sent to an alarm receiving center; at least one of an SMS message, a MMS message, a video clip, and an audio clip sent to a predetermined location; and a telephone call placed to a predetermined party.

6. The method according to claim 1 further comprising the steps (a0a) through (a0f) performed before step (a):
(a0a) running a recording function by the application;
(a0b) receiving input for a plurality of parameters for a four-dimensional gesture pattern;
(a0c) generating an audible signal to indicate a start of the recording;
(a0d) measuring and recording movements of the mobile device for the four-dimensional gesture pattern;
(a0e) receiving input to stop the recording of the four-dimensional gesture pattern; and
(a0f) storing the four-dimensional gesture pattern in a memory of the mobile device.

7. The method according to claim 6 further comprising the step of:
receiving input that the four-dimensional gesture pattern is at least one of the prerecorded trigger gesture pattern and the one or more prerecorded event gesture patterns.

8. The method according to claim 7 further comprising the step of:
when the four-dimensional gesture pattern to be recorded is one of the one or more prerecorded event gesture patterns, receiving selection input from a list of predefined events selected from the group consisting of a personal attack, a medical alert, a threatening situation, and a check-in.

9. The method according to claim 6 further comprising the step of:
receiving input for the plurality of parameters selected from the group consisting of a maximum amount of time to complete the four-dimensional gesture pattern; an acceptable time deviation for the four-dimensional gesture pattern; an acceptable g-force deviation for the four-dimensional gesture pattern; and a number of recordings to produce an averaged baseline recording of the four-dimensional gesture pattern.

10. The method according to claim 9 further comprising the steps of:
repeating steps (a0c) through (a0f) until the number of recordings to produce the averaged baseline recording has been met;
averaging the number of recordings together to produce the averaged baseline recording; and
storing the averaged baseline recording in the memory of the mobile device.

11. The method according to claim 6 wherein measuring the four-dimensional gesture pattern step (a0d) further comprises the steps of:
measuring and recording one or more movements of the mobile device with an accelerometer located within the mobile device;
measuring and recording the one or more movements of the mobile device with a gyroscope located within the mobile device;
measuring and recording the one or more movements of the mobile device with a magnetometer located within the mobile device; and
measuring and recording a time of the one or more movements of the mobile device with an internal clock located within the mobile device.

12. A method for mobile security, the method comprising the steps of:
(a) running a recording function of an application running in a mobile device;
(b) receiving input for a plurality of parameters for a four-dimensional gesture pattern;
(c) generating an audible signal to indicate a start of the recording;
(d) measuring and recording movements of the mobile device for the four-dimensional gesture pattern;
(e) receiving input to stop the recording of the four-dimensional gesture pattern; and
(f) storing the four-dimensional gesture pattern in a memory of the mobile device.

13. The method according to claim 12 further comprising the step of:
receiving input that the four-dimensional gesture pattern is at least one of a trigger gesture pattern and one or more event gesture patterns.

14. The method according to claim 13 further comprising the step of:
when the four-dimensional gesture pattern recorded is one of the one or more event gesture patterns, receiving selection input from a list of predefined events selected from the group consisting of a personal attack, a medical alert, a threatening situation, and a check-in.

15. The method according to claim 12 further comprising the step of:
receiving input for the plurality of parameters selected from the group consisting of a maximum amount of time to complete the four-dimensional gesture pattern; an acceptable time deviation for the four-dimensional gesture pattern; an acceptable g-force deviation for the four-dimensional gesture pattern; and a number of recordings to produce an averaged baseline recording of the four-dimensional gesture pattern.

16. The method according to claim 15 further comprising the steps of:
repeating steps (c) through (f) until the number of recordings to produce the averaged baseline recording has been met;
averaging the number of recordings together to produce the averaged baseline recording; and
storing the averaged baseline recording in the memory of the mobile device.

17. The method according to claim 12 wherein measuring the four-dimensional gesture pattern step (d) further comprises the steps of:
measuring and recording one or more movements of the mobile device with an accelerometer located within the mobile device;
measuring and recording the one or more movements of the mobile device with a gyroscope located within the mobile device;
measuring and recording the one or more movements of the mobile device with a magnetometer located within the mobile device; and
measuring and recording a time of the one or more movements of the mobile device with an internal clock located within the mobile device.

18. The method according to claim 13 further comprising the steps of:
(g) monitoring by the application running in the mobile device for the trigger gesture pattern;
(h) detecting by the application a gesture pattern;
(i) determining by the application if the gesture pattern detected matches the trigger gesture pattern;
(j) if the gesture pattern detected matches the trigger gesture pattern, monitoring by the application for a next gesture pattern;
(k) detecting by the application the next gesture pattern;
(l) comparing by the application the next gesture pattern to the one or more event gesture patterns; and
(m) when the next gesture pattern detected matches one of the one or more event gesture patterns, executing by the application a set of instructions associated with the one or more event gesture patterns that has been matched.

19. The method according to claim 18 further comprising the step of:
if the next gesture pattern is not detected with a predetermined period of time from detection of the trigger gesture pattern, sending by the application a first predefined general alarm to an alarm receiving center.

20. The method according to claim 19 further comprising the step of:
if the next gesture pattern is detected within the predetermined period of time from detection of the trigger gesture pattern but is not matched with any of the one or more event gesture patterns, sending by the application a second predefined general alarm to the alarm receiving center.

21. The method according to claim 20 further comprising the step of:
sending by the application a GPS location of the mobile device along with the first predefined general alarm or the second predefined general alarm.

22. The method according to claim 18 further comprising the step of:
executing the set of instructions selected from the group consisting of one or more of an alarm signal sent to an alarm receiving center; at least one of an SMS message, a MMS message, a video clip, and an audio clip sent to a predetermined location; and a telephone call placed to a predetermined party.

23. A non-transitory computer readable storage medium for storing instructions that, when executed by a processor, cause the processor to perform a method for mobile security, the method comprising the steps of:
(a) running a recording function of an application running in a mobile device;
(b) receiving input for a plurality of parameters for a four-dimensional gesture pattern;
(c) generating an audible signal to indicate a start of the recording;
(d) measuring and recording movements of the mobile device for the four-dimensional gesture pattern;
(e) receiving input to stop the recording of the four-dimensional gesture pattern; and
(f) storing the four-dimensional gesture pattern in a memory of the mobile device.

24. The non-transitory computer readable storage medium according to claim 25 further comprising the step of:
receiving input that the four-dimensional gesture pattern is at least one of a trigger gesture pattern and one or more event gesture patterns.

25. The non-transitory computer readable storage medium according to claim 24 further comprising the step of:
(g) monitoring by the application running in the mobile device for the trigger gesture pattern;
(h) detecting by the application a gesture pattern;
(i) determining by the application if the gesture pattern detected matches the trigger gesture pattern;
(j) if the gesture pattern detected matches the trigger gesture pattern, monitoring by the application for a next gesture pattern;
(k) detecting by the application the next gesture pattern;
(l) comparing by the application the next gesture pattern to the one or more event gesture patterns; and
(m) when the next gesture pattern detected matches one of the one or more event gesture patterns, executing by the application a set of instructions associated with the one or more event gesture patterns that has been matched.
